(19) United States
(12) Patent Application Publication
(10) Pub. No.: US 2023/0077973 A1
(43) Pub. Date: Mar. 16, 2023

(54) DEVICE AND METHOD FOR DETECTING COUNTERFEIT IDENTIFICATION CARD

(71) Applicant: Fullstack Inc., Seoul (KR)

(72) Inventors: Wonkyu Lee, Seoul (KR); Sungho Son, Seoul (KR); Jaehun Song, Seoul (KR)

(73) Assignee: Fullstack Inc., Seoul (KR)

(21) Appl. No.: 17/943,190

(22) Filed: Sep. 12, 2022

(30) Foreign Application Priority Data
Sep. 15, 2021 (KR) 10-2021-0122923

(51) Int. Cl. G06V 30/224; G06V 10/82

(52) U.S. Cl. CPC G06V 30/224; G06V 10/82; G06Q 50/265

(57) ABSTRACT

A device for determining an ID card includes an image input unit to acquire an initial image including an ID card image, an image pre-processing unit to generate a processed image by removing a remaining portion of the initial image except for the ID card image, and generate a first training image having a first resolution value and a second training image having a second resolution value, based on the processed image, an image determining unit to determine whether an identifying mark is present on the processed image, based on an artificial intelligence (AI) model based on a neural network trained by training data including the first training image and the second training image, and a model evaluating unit to calculate a plurality of parameters by using a determination result of the image determining unit and to evaluate the AI model based on the plurality of parameters.

### CROSS-REFERENCE TO RELATED APPLICATIONS

This application claims priority under 35 U.S.C. § 119 to Korean Patent Application No. 10-2021-0122923 filed on Sep. 15, 2021, in the Korean Intellectual Property Office, the disclosures of which are incorporated by reference herein in their entireties.

### BACKGROUND

Embodiments of the present disclosure described herein relate to a device for detecting a counterfeit identification card, and more particularly, relate to a device for detecting a counterfeit identification (ID) card by determining whether an identifying mark is present on an ID card.

An ID card may be to verify the personal details or the identity of a person, and a representative ID card may include a resident registration card, a driver's license, a passport, a student card, a youth card, and a disability card. The ID card may be used for verifying the identify of a person having the ID card in an airport, a test site, or a bank.

However, recently, as a technology of forging the ID card is developed, a counterfeit ID card may be easily made, and the risk of impersonating others with the counterfeit ID card is increasing. To cope with the problem, an ID card issuing agency prints various identifying marks on an ID card, such that the ID card is determined as a genuine ID card and not a counterfeit ID card. The identifying mark cannot be made through a forging technology. Accordingly, the identifying mark becomes a symbol to determine whether the ID card is counterfeited. Accordingly, there has been introduced a device for automatically scanning an ID card using the identifying mark and determining whether the ID card is counterfeited by using the identifying mark.

### SUMMARY

Embodiments of the present disclosure are to detect a counterfeit ID card by determining whether an identifying mark is present on an ID card.

Embodiments of the present disclosure are to evaluate the performance of an artificial intelligent (AI) model used for determining an ID card.

According to an embodiment, a device for determining an ID card to detect a counterfeit ID card may include an image input unit to acquire an initial image including an ID card image, an image pre-processing unit to generate a processed image by removing a remaining portion of the initial image except for the ID card image, and generate a first training image having a first resolution value and a second training image having a second resolution value, based on the processed image, an image determining unit to determine whether an identifying mark is present on the processed image, based on an artificial intelligence (AI) model based on a neural network trained by training data including the first training image and the second training image, and a model evaluating unit to calculate a plurality of parameters by using a determination result of the image determining unit and to evaluate the AI model based on the plurality of parameters.

In this case, the identifying mark may be a hologram or a micro-printed character.

In this case, the image pre-processing unit may generate the processed image by cropping an image, which is obtained by removing the remaining portion of the initial image except for the ID card image, to be in a specific size.

In this case, the plurality of parameters may include at least one precision, recall, and an area under curve (AUC) score.

In this case, the plurality of parameters may be calculated based on True Positive (TP), False Positive (FP), True Negative (TN), and False Negative (FN) calculated by using the determination result.

In this case, the device may further include a result outputting unit to output at least one of the determination result and the plurality of parameters.

In this case, the image determining unit may determine whether the identifying mark is present, based on a threshold value, which is determined based on a False Acceptance Rate (FAR), and a False Rejection Rate (FRR), and may adjust the threshold value based on the plurality of parameters.

According to an embodiment, a method for detecting a counterfeit ID card may include acquiring an initial image including an ID card image, generating a processed image by removing a remaining portion of the initial image except for the ID card image, generating a first training image having a first resolution value and a second training image having a second resolution value, based on the processed image, training an artificial intelligence (AI) model based on a neural network trained by training data including the first training image and the second training image, determining whether the identifying mark is present on the processed image, based on the AI model, calculating a plurality of parameters by using a determination result in the determining of whether the identifying mark is present on the processed image, and evaluating the AI model based on the plurality of parameters.

In this case, the identifying mark may be a hologram or a micro-printed character.

In this case, the generating of the processed image may include cropping an image, which is obtained by removing the remaining portion of the initial image except for the ID card image, to be in a specific size.

In this case, the plurality of parameters may include at least one precision, recall, and an area under curve (AUC) score.

In this case, the calculating of the plurality of parameters may calculating the plurality of parameters based on True Positive (TP), False Positive (FP), True Negative (TN), and False Negative (FN) calculated by using the determination result.

In this case, the method may further include outputting at least one of the determination result and the plurality of parameters.

In this case, the determining of whether the identifying mark is present may include determining whether the identifying mark is present, based on a threshold value, which is determined based on a False Acceptance Rate (FAR), and a False Rejection Rate (FRR), and adjusting the threshold value based on the plurality of parameters.

In addition, a computer program stored in a computer-readable recording medium may be provided to execute a method for detecting the counterfeit ID card.

### BRIEF DESCRIPTION OF THE FIGURES

The above and other objects and features of the present disclosure will become apparent by describing in detail embodiments thereof with reference to the accompanying drawings.

FIG. 1 is a view illustrating an image of an ID card;

FIG. 2 is a block diagram of a device for determining an ID card, according to an embodiment;

FIG. 3 is a flowchart illustrating a manner for training an artificial intelligence (AI) model for a device for determining an ID card, according to an embodiment;

FIG. 4 is a graph for determining a threshold value used to determine whether an ID card image is counterfeited;

FIG. 5 is a flowchart illustrating a manner for determining an ID card by a device for determining the ID card, according to an embodiment;

FIG. 6 is a flowchart illustrating a manner for evaluating an AI model for a device for determining an ID card, according to an embodiment;

FIG. 7 is a view illustrating a result output image of a device for determining an ID card, according to an embodiment;

FIG. 8 is a flowchart illustrating a manner for training an artificial intelligence (AI) model for a device for determining an ID card, according to another embodiment;

FIG. 9 is a view illustrating an image pre-processing to extract an identifying mark by a device for determining an ID card, according to another embodiment; and

FIGS. 10A and 10B is a view illustrating the steps of comparing pixel values to extract an identifying mark by a device for determining an ID card, according to another embodiment.

### DETAILED DESCRIPTION

Embodiments described in the specification are for clearly explaining the spirit of the present disclosure to one skilled in the art to which the present disclosure pertains, so the present disclosure is not limited to the embodiments described in the specification. The scope of the present disclosure should be construed to include various modifications, equivalents, and/or alternatives of the embodiments without departing from the spirit of the present disclosure.

The terms used in the specification may be selected as widely used general terms as possible in consideration of functions in the present disclosure but may vary depending on the intention of one skilled in the art to which the present disclosure belongs, precedent, or emergence of new technologies. However, when a specific term is defined and used with an arbitrary meaning, the meaning of the term will be separately described. Hence, the terms used in the specification should be interpreted based on the actual meanings of the terms and the contents throughout the specification, rather than the simple names of the terms.

Drawings attached to the specification are for easily explaining the present disclosure, and because the shapes shown in the drawings may be exaggerated as necessary for better understanding of the present disclosure, the present disclosure is not limited by the drawings.

In the specification, when it is determined that a detailed description of a known configuration or function related to the present disclosure may obscure the gist of the present disclosure, the detailed description thereof will be omitted if necessary.

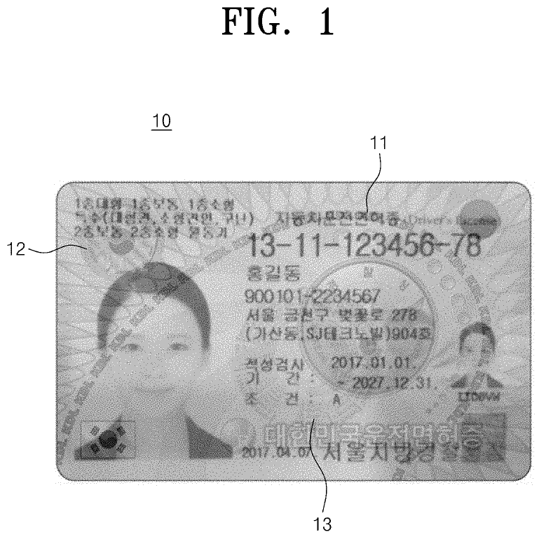

FIG. 1 is a view illustrating an image of an ID card.

Referring to FIG. 1, an ID card 10 may include an ID type 11, a hologram 12, and a micro-printed character 13 in an image. In this case, the hologram 12 and the micro-printed character 13 may be identifying marks for determining whether the ID card 10 is counterfeited.

FIG. 1 illustrates a driver's license as an example of the ID card 10. However, the present disclosure is not limited thereto. ID cards to be determined by the device for determining the ID card according to the present disclosure may include a resident registration card, a passport, a civil service card, a national technical certificate, a welfare card (disability registration card), a national merit card, a crew card, a teacher certificate, the service of military services, and a Jeju Island ID card.

The type of the ID card 10 is written in the form of characters in a space for the ID type 11. Various ID cards for verifying an ID of a user may be targets to be determined by the device (hereinafter, an ID card determining device for determining the ID card according to the present disclosure), in addition to the above-listed ID types 11. In addition, even an ID card in another nation except for Korea may be a target to be determined by the ID card determining device according to the present disclosure.

In general, the ID card 10, which is a typical genuine ID card, may have the hologram 12 which is the identifying mark. For example, a resident registration card has a Taegeuk-patterned hologram overlapped and displayed on a name, a resident registration number, and a photo. In addition, a driver's license of FIG. 1 has a Taegeuk-patterned hologram displayed on a portrait.

In addition, a resident registration card issued after Jan. 1, 2020 has a band-patterned hologram formed on the entire portion of the resident registration card, in addition to the Taegeuk-patterned (on Korean flag) hologram formed on the name, the resident registration number, and the photo. Since the ID card 10, which is a genuine ID card, has the hologram 12, the color of the genuine ID card 10 is varied depending on the direction of light. However, a counterfeit ID card has no hologram 12, so the color of the counterfeit ID card is not changed even though the direction of light is changed.

In addition, the genuine ID card 10 may include the micro-printed character 13 which is an Identifying mark. For example, the driver's license of FIG. 1 may have the wording of “DRIVER'S LICENSE” repeatedly marked in a small size at the right side of a portrait.

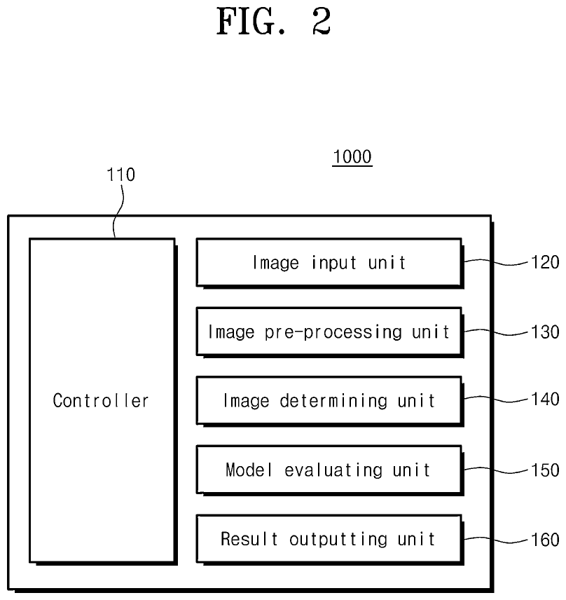

FIG. 2 is a block diagram of a ID card determining device, according to an embodiment.

Referring to FIG. 2, the ID card determining device 1000 may include a controller 110, an image input unit 120, an image pre-processing unit 130, an image determining unit 140, a model evaluating unit 150, and a result outputting unit 160.

The controller 110 may perform the overall control operation of the ID card determining device 1000. Accordingly, the image input unit 120, the image pre-processing unit 130, the image determining unit 140, the model evaluating unit 150, and the result outputting unit 160 may perform the intrinsic functions thereof by the controller 110. The controller 110 may be a unit that provides a control program instruction in one or more computer-readable storage media.

The image input unit 120 may receive, store, and/or transmit an initial image including an ID card image. For example, the ID card determining device 1000 may scan the initial image through the image input unit 120. In this case, the image input unit 120 may include an image scan device, and may be a computer program in itself. The image input unit 120 may transmit the acquired initial image to the image pre-processing unit 130. The image input unit 120 may be a processor that provides a program instruction related to inputting image.

The image pre-processing unit 130 may acquire the initial image from the image input unit 120. The image pre-processing unit 130 may perform a pre-processing operation with respect to the acquired initial image. The image pre-processing unit 130 may be a processor that provides a program instruction related to pre-processing image.

In detail, the image pre-processing unit 130 may generate a processed image by removing a remaining portion of the initial image except for the ID card image. For example, the image pre-processing unit 130 may extract the ID card image by detecting the largest rectangle in the initial image.

Thereafter, the image pre-processing unit 130 may generate the processed image based on the ID card image by cropping an unnecessary image portion, such as a background image, which is extracted from the initial image, except for the ID card image. In this case, the image pre-processing unit 130 may crop the initial image such that the processed image has the specific image.

The image pre-processing unit 130 may transmit the processed image, which is generated, to the image determining unit 140, Accordingly, the image pre-processing unit 130 may perform the pre-processing operation with respect to the acquired initial image, such that the image determining unit 140 easily determine the processed image having a standard size.

In addition, the image pre-processing unit 130 may generate a training image for training an AI model by variously changing the processed image. For example, the image pre-processing unit 130 may generate a first training image by allowing the processed image to have 64-bit resolution. In addition, the image pre-processing unit 130 may generate a second training image by allowing the processed image to have 128-bit resolution.

In addition, the image pre-processing unit 130 may generate a third training image and a fourth training image, by allowing the processed image to have 256-bit resolution or 512-bit resolution, respectively. In addition to the above illustrative resolutions, the image pre-processing unit 130 may generate/store a plurality of training images having various resolutions by changing the resolution of the processed image. The image pre-processing unit 130 may transmit a plurality of training images, which are generated, to the image determining unit 140. The plurality of training images may be used to train the AI model of the image determining unit 140.

The image determining unit 140 may determine whether an identifying mark is present on the processed image which is acquired from the image pre-processing unit 130. In detail, the image determining unit 140 may determine whether the identifying mark is present on the processed image, based on an AI model based on a neural network. For example, the AI model may be ResNet-50 based on a convolution neural network (CNN), but the present disclosure is not limited thereto. The image determining unit 140 may be a processor that provides a program instruction related to determining image.

The image determining unit 140 may determine whether an ID card is genuine or counterfeit, by determining whether the hologram 12 and/or the micro-printed character 13 are included in the processed image. In this case, the image determining unit 140 may employ a typical manner for recognizing the hologram 12 or the micro-printed character 13 from the processed image through a manner such as optical character recognition (OCR).

The image determining unit 140 may transmit a result (a determination result), which is obtained by determining whether the identifying mark is present on the processed image, to the model evaluating unit 150 and/or the result outputting unit 160.

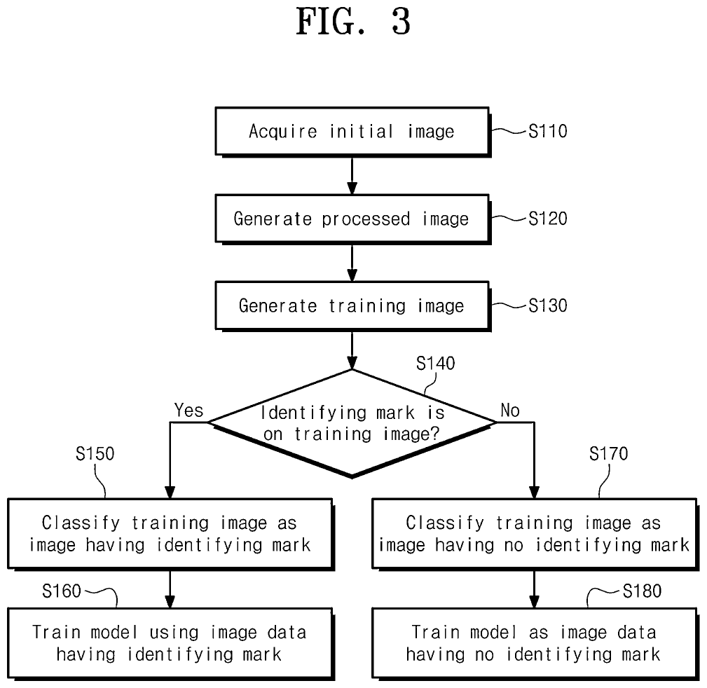

In addition, the image determining unit 140 may acquire a plurality of training images from the image pre-processing unit 130. The image determining unit 140 may train the AI model based on the plurality of training images. A manner for training the AI model will be described in detail with reference to FIG. 3.

The image determining unit 140 may transmit a notification to another device through the controller 110, when the determination result indicates the ID card counterfeited. For example, when the determination result of the image determining unit 140 indicates the ID card counterfeited, the controller 110 may transmit information on the ID card counterfeited to an external server (a police server, a bank server, or a security server) through a communication unit of the ID card determining device 1000.

The information on the ID card counterfeited may include the type of an ID card, and a time point and a position at which the ID card is determined. The ID card determining device 1000 and/or the external server having the received information on the ID card counterfeited may give a notification to a person having a name written on the ID card. The information on the notification may include information on the ID card counterfeited and a guidance message for managing with the counterfeiting accident. The coping guidance message may include a message for advising the person to check the bank information, to change a photo, to enhance information security, or to change a password.

The model evaluating unit 150 may receive the determination result from the image determining unit 140. The model evaluating unit 150 may calculate a plurality of parameters by using the determination result. For example, the model evaluating unit 150 may calculate precision, recall, an area under curve (AUC) score. The model evaluating unit 150 may be a processor that provides a program instruction related to evaluating AI model.

The model evaluating unit 150 may transmit the plurality of parameters, which are calculated, to the controller 110 and/or the result outputting unit 160. The controller 110 may evaluate the AI model based on the plurality of parameters received from the model evaluating unit 150. In addition, the result outputting unit 160 may output the plurality of parameters received from the model evaluating unit 150.

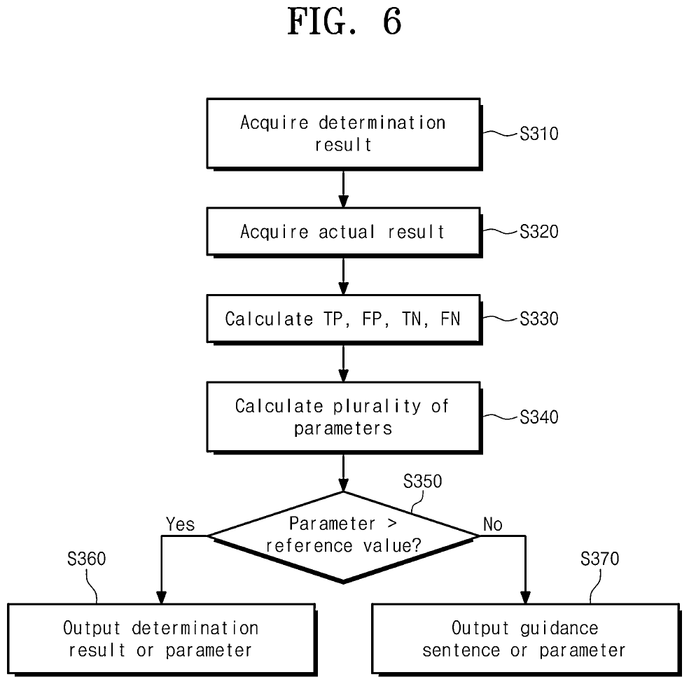

The manner for evaluating the AI model by the model evaluating unit 150 will be described in detail with reference to FIG. 6.

The result outputting unit 160 may output the determination result acquired from the image determining unit 140 and/or the plurality of parameters acquired from the model evaluating unit 150. The output form may be the form of a display or a voice. The result outputting unit 160 may be a processor that provides a program instruction related to outputting results.

According to an embodiment, the result outputting unit 160 includes a display to output visual information. For example, the result outputting unit 160 includes a liquid crystal display (LED), an organic light emitting diode (OLED), or an active matrix organic light-emitting diode (AMOLED) display to output the determination result and/or the plurality of parameters.

According to another embodiment, the result outputting unit 160 includes a voice output device to output voice information. For example, the result outputting unit 160 includes a speaker or a buzzer to output the determination result and/or the plurality of parameters.

FIG. 3 is a flowchart illustrating a manner for training an artificial intelligence (AI) model for a device for determining an ID card, according to an embodiment.

Referring to FIG. 3, the manner for training the AI model by the ID card determining device may include acquiring an initial image (S110), generating a processed image (S120), generating a training image (S130), determining whether an identifying mark is present on the training image (S140), classifying the processed image depending on whether the identifying mark is present (S150 and S170), and training the AI model (S160 and S180) depending on whether the identifying mark is present.

The acquiring of the initial image (S110) may include acquiring the initial image including the ID card image by the image input unit 120.

The generating of the processed image (S120) may include acquiring the initial image from the image input unit 120, and generating the processed image based on the ID card image by cropping the initial image, by the image pre-processing unit 130.

The generating of the training image (S130) may include generating the training image for training the AI model by adjusting the resolution of the processed image, by the image pre-processing unit 130. In other words, the ID card determining device 1000 may training the AI model by variously changing the resolution with respect to the same ID card. This is to complement the problem of the determination result to be changed depending on the scan state of the ID card. Accordingly, the counterfeit ID card may be more precisely detected regardless of the scan state.

The determining of whether the identifying mark is present on the training image (S140) may include determining, by the image determining unit 140, whether the hologram 12 and/or the micro-printed character 13 is present on the training image by using the AI model.

When the identifying mark is present on the training image, the training image may be classified as an image having the identifying mark (S150). The images classified in S150 may be used to train the AI model (S160), with the identifying mark.

When the identifying mark is absent on the training image, the training image is classified as an image having no identifying mark (S170). The images classified in S170 may be used to train the AI model, without the identifying mark (S180).

According to various embodiments, the sequence of S130 and S140 of FIG. 3 may be changed. In other words, after generating the processed image (S120), whether the identifying mark is present on the processed image may be determined.

When the identifying mark is present on the processed image, a first modified image having a first resolution value and a second modified image having a second resolution value may be generated by changing the resolution of the processed image. Thereafter, the first modified image and the second modified image may be classified as images having identifying marks, and the classified images may be used to train the AI mode with the identifying mark.

When the identifying mark is absent on the processed image, a third modified image having a third resolution value and a fourth modified image having a fourth resolution value may be generated by changing the resolution of the processed image. Thereafter, the third modified imaged and the fourth modified image may be classified as images having no identifying mark, and the classified images may be used to train the AI mode without the identifying mark.

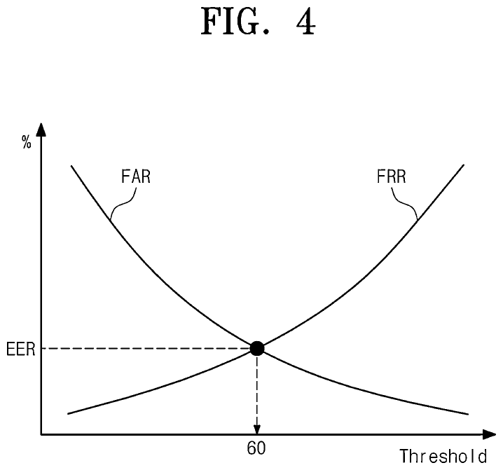

FIG. 4 is a graph for determining a threshold value used to determine whether an ID card image is counterfeited.

Referring to FIG. 4, the threshold value may be determined based on a false acceptance rate (FAR) and a false rejection rate (FRR). The FAR may refer to the probability in which a counterfeit ID card is erroneously determined as the genuine ID card. The FRR may refer to the probability in which the genuine ID card is erroneously determined as the counterfeit ID card.

As illustrated in FIG. 4, the FAR may be decreased, as the threshold value is increased. To the contrary, the FRR may be increased, as the threshold value is increased. Accordingly, the threshold value needs to be determined such that the FAR and the FRR have appropriate values.

According to an embodiment, the threshold value may be determined such that the FAR and the FRR may have the same value. In other words, the image determining unit 140 may determine the threshold value to satisfy an equal error rate (EER) indicating that the FAR is equal to the FRR. For example, although the image determining unit 140 may determine the threshold value as ‘60’ allowing the FAR and FRR to reach 20%, the present disclosure is not limited thereto.

The threshold value may be automatically determined depending on AI models. The threshold value may be automatically determined depending on the algorithm of the ID card determining device. In addition, the threshold value may be adjusted depending on the determination result of the ID card determining device.

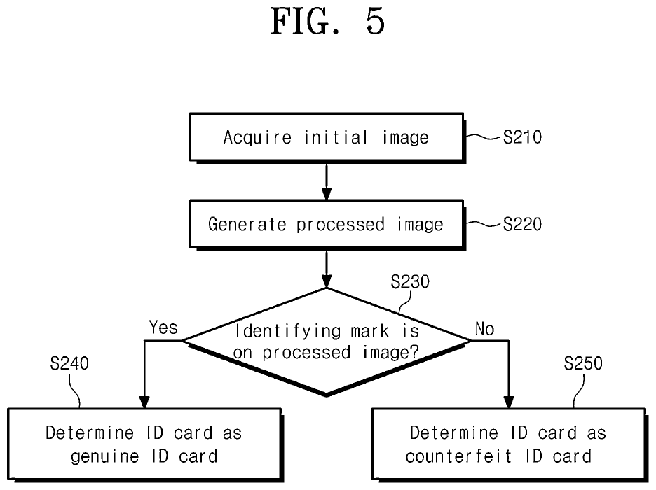

FIG. 5 is a flowchart illustrating a manner for determining an ID card by a device for determining an ID card, according to an embodiment. The manner for determining an ID card may be determined by the image determining unit 140.

Referring to FIG. 5, the manner for determining the ID card may include acquiring an initial image (S210), generating a processed image (S220), determining whether an identifying mark is present on the processed image (S230), and determining the genuineness the ID card, depending on whether the identifying mark is present (S240 and S250).

The description about acquiring the initial image (S210) and generating the processed image (S220) may be the duplications of acquiring the initial image (S110) and generating the processed image (S120) in FIG. 3. Accordingly, the details thereof will be omitted to avoid redundancy.

The determining of whether the identifying mark is present on the processed image (S230) may include determining, by the image determining unit 140, whether the hologram 12 and/or the micro-printed character 13 is present on the training image by using the AI model.

When the identifying mark is present on the processed image, the image determining unit 140 may determine the ID card as the genuine ID card. When the identifying mark is absent on the processed image, the image determining unit 140 may determine the ID card as the counterfeit ID card.

The image determining unit 140 may transmit the determination result of the genuineness of the ID card to the controller 110, the model evaluating unit 150, and/or the result outputting unit 160.

FIG. 6 is a flowchart illustrating a manner for evaluating an artificial intelligence (AI) model for a device for determining an ID card, according to an embodiment. The manner for evaluating the AI model may be performed by the model evaluating unit 150.

Referring to FIG. 6, the manner for evaluating the AI model may include acquiring the determination result (S310), acquiring an actual result (S320), calculating True Positive (TP), False Positive (FP), True Negative (TN), and False Negative (FN) (S330), calculating a plurality of parameters (S340), comparing the plurality of parameters with a reference value (S350), and outputting the determination result, a guidance sentence, or the plurality of parameters, based on the result of S350 (S370).

The acquiring of the determination result (S310) may include acquiring, by the model evaluating unit 150, the determination result from the image determining unit 140. In detail, S310 may include acquiring a determination result of the genuineness of the ID card by the image determining unit 140 based on whether the identifying mark is present.

The acquiring of the actual result (S320) may include acquiring the determination result on whether the ID card scanned by the image input unit 120 is actually a genuine ID card or a counterfeit ID card. S320 may include receiving an input into the image input unit 120 or a separate input unit from a user or an additional server of the ID card determining device.

The calculating of TP, FP, TN, and FN (S330) may include calculating TP, FP, TN, and FN, based on results acquired in S310 and S320.

The TP may mean that the ID card determining device determines the ID card as a genuine ID card and that the ID card is actually genuine. In other words, the TP may refer to that the result of the image determining unit 140 of the ID card determining device 1000 and the result obtained in S320 indicate the ID card as the genuine ID card. In this case, the determination of the ID card determining device 1000 may be true.

The TN may mean that the ID card determining device determines the ID card as a counterfeit ID card, but the ID card is actually genuine. In other words, the TN may refer to that the result of the image determining unit 140 of the ID card determining device 1000 indicates the ID card as the counterfeit ID card, and the result obtained in S320 indicates the ID card as the genuine ID card. In this case, the determination of the ID card determining device 1000 may be false.

The FP may mean that the ID card determining device determines the ID card as a genuine ID card, but the ID card is actually counterfeit. In other words, the FP may refer to that the result of the image determining unit 140 of the ID card determining device 1000 indicates the ID card as the genuine ID card, and the result obtained in S320 indicates the ID card as the counterfeit ID card. In this case, the determination of the ID card determining device 1000 may be false.

The FN may mean that the ID card determining device determines the ID card as a counterfeit ID card, and the ID card is actually counterfeit. In other words, the FN may refer to that the result of the image determining unit 140 of the ID card determining device 1000 indicates the ID card as the counterfeit ID card, and the result obtained in S320 indicates the ID card as the counterfeit ID card. In this case, the determination of the ID card determining device 1000 may be true.

The calculating of the plurality of parameters (S340) may include calculating precision, recall, and an area under curve (AUC) score by using the TP, FP, TN, and FN calculated above.

The precision may refer to the ratio of images really having holograms to images determined as having holograms. The precision may be calculated based on the TP and the FP. In detail, the precision may be calculated based on the equation of TP/(TP+FP).

The recall may refer to the ratio of images really determined as holograms to the whole hologram images. The recall may be calculated based on the TP and the FP. In detail, the recall may be calculated based on the equation of TP/(TP+FN)

The AUC score may refer to a score indicating the classification performance of the AI model. The AUC score may be calculated through a region under a graph (a receiver operating characteristic; ROC) curve showing the classification performance of the AI model at all threshold values.

The comparing of the plurality of parameters with the reference value (S350) may include comparing each of the parameters calculated in S340 with a specific value. For example, although the precision is 60% or more, it may be determined whether the recall is 60% or more, and the AUC score is 0.5 or more, the present disclosure is not the numeric values.

The reference value may be stored by the ID card determining device 1000 in advance. In addition, the reference value may be changed depending on the type of the ID card or the type of the parameter.

The plurality of parameters are compared with the reference value in S350 because the ID card determining device 1000 is reliable when the plurality of parameters is the reference value or more.

Each parameter is greater than the reference value, which refers to that the result of the ID card determining device 1000 is reliable. Accordingly, the ID card determining device 1000 may output the determination result of the image determining unit 140 and/or the plurality of parameters by the result outputting unit 160.

Each parameter is less than the reference value, which refers to that the reliability for the result of the ID card determining device 1000 is lower. Accordingly, the ID card determining device 1000 may output the guidance message and/or the plurality of parameters by the result outputting unit 160. In this case, the guidance message may have the meaning that the ID card determining device 1000 is failed or has lower reliability.

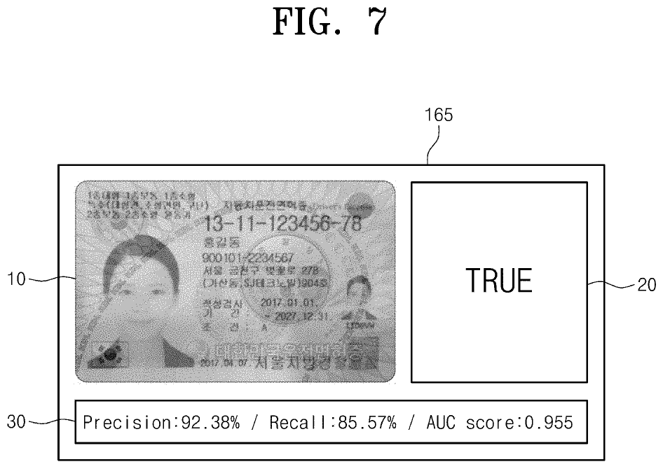

FIG. 7 is a view illustrating a result output image of a device for determining an ID card, according to an embodiment.

Referring to FIG. 7, the result outputting unit 160 of the ID card determining device 1000 may output a result output image 165. The result output image 165 of FIG. 7 is provided only for the illustrative purpose, and the present disclosure is not limited thereto.

According to an embodiment, the result output image 165 may include an ID card 165, a determination result 20, and a plurality of parameters 30.

The ID card 10 may have an initial image, a processed image and/or an ID card image. The determination result 20 may be the wording for representing the determination result of the ID card determining device 1000. The plurality of parameters 30 may be the wording for representing the calculating result of the model evaluating unit 150.

According to the present disclosure, the ID card determining device 1000 may output the plurality of parameters together with whether the ID card is counterfeited, such that the reliability of the ID card determining device 1000 is output in the form of visual information. Accordingly, when an internal algorithm is failed, a user may recognize the failed internal algorithm based on the output result of the result outputting unit 160.

Although FIG. 7 illustrates the visual output information of the ID card determining device 1000, the present disclosure is not limited thereto. The ID card determining device 1000 may output, in the form of voice, the determination result and the plurality of parameters.

The determining whether the identifying mark is present on the image of the ID card has been described with reference to FIGS. 3 and 5. However, according to the present disclosure, the ID card determining device may determine whether the identifying mark is present on the ID card, by using a video instead of an image. In this case, the video may be obtained by photographing an ID card at various angles.

According to the present disclosure, the ID card determining device may determine whether the identifying mark is present on the ID card, by comparing pixel values of pixels, which correspond to regions of the ID card of the video, with each other. In detail, according to the present disclosure, the ID card determining device may determine whether pixel values of specific pixels of the video have the change of at least a threshold value over time, thereby determining whether the identifying mark is present on the ID card. The color of the hologram of the ID card is changed depending on angles. Accordingly, the ID card determining device may determine whether the hologram is present on the ID card by detecting that the pixel value of the specific pixel is significantly changed depending on angles.

Hereinafter, the ID card determining device determining whether the identifying mark is present, by using the image will be described.

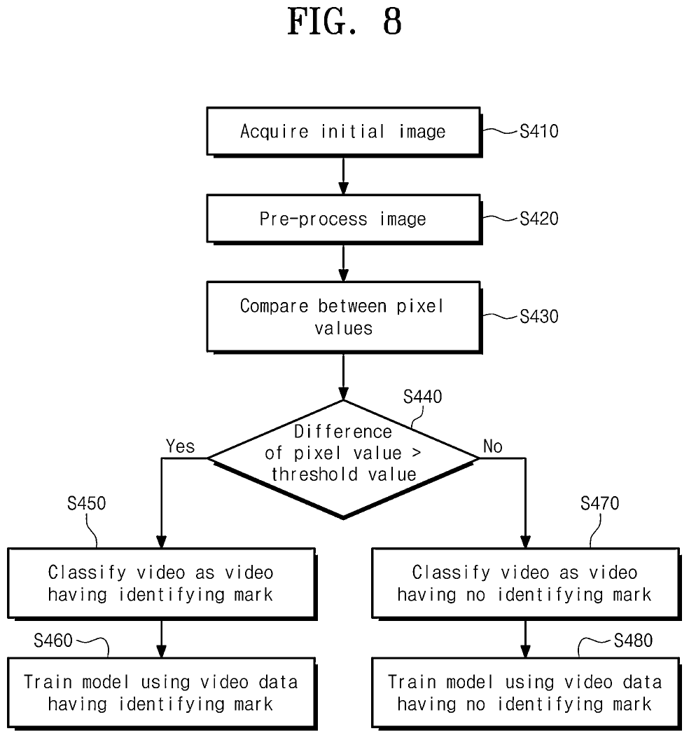

FIG. 8 is a flowchart illustrating a manner for training an artificial intelligence (AI) model for a device for determining an ID card, according to another embodiment.

Referring to FIG. 8, the manner for training the AI model by the ID card determining device according to the present disclosure may include acquiring an initial image (S410), pre-processing a video (S420), comparing pixel values of pixels in the video with each other (S430), determining whether the difference between the pixels values is equal to or greater than a threshold value (S440), classifying a video depending on whether the identifying mark is present, based on the comparison result between the pixel value and the threshold vale (S450 and S470), and training the AI model depending on whether the identifying mark is present (S460 and S480).

The acquiring of the initial image (S410) may include acquiring an initial image including the ID card image, by the image input unit 120.

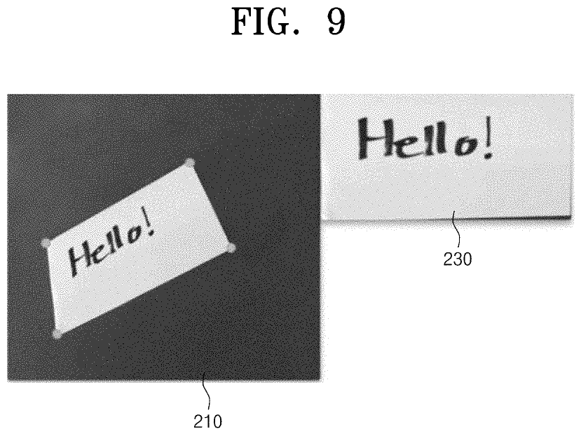

The pre-processing of the video (S420) may include acquiring the initial image from the image input unit 120 by the image pre-processing unit 130, and generating the processed image based on the ID card image by cropping the initial image. The details of the pre-processing operation for the video will be described with reference to FIG. 9.

FIG. 9 is a view illustrating a pre-processing operation for a video to extract an identifying mark by the ID card determining device, according to another embodiment. Referring to FIG. 9, the image pre-processing unit 130 may pre-process an image 210 of each frame of the video. In detail, the image pre-processing unit 130 may crop an image based on an ID card image 230, within the image 210 of each frame. In addition, the image pre-processing unit 130 may rotate the cropped image such that the front of the ID card image 230 is straightly viewed. In detail, the image pre-processing unit 130 may rotate the cropped image such that the character in the ID card image 230 is not inclined.

The image pre-processing unit 130 may transform the image to a grayish image to reduce color noise of the image, in the process of pre-processing each frame of the image. In addition, the image pre-processing unit 130 may find a sharp edge from the image through a canny edge detection algorithm.

The image pre-processing unit 130 may use a function of finding a set of all squares larger than a preset area threshold value by using an edge. The image pre-processing unit 130 may find an ID card image, which has the largest square, in the set of squares by using the length of arc. The image pre-processing unit 130 may transform the found ID image into the image having a specific size.

Referring to FIG. 8 again, the comparing (S430) of pixel values of pixels in the video with each other may include analyzing a pixel value in a video of each frame of the video which is pre-processed in S420, by the image determining unit 140. In detail, the image determining unit 140 may compare a pixel value of a first pixel corresponding to a first region of the ID card image 230 in the first frame with a pixel value of the first pixel corresponding to the first region of the ID image 230 in the second frame. The image determining unit 140 may consecutively compare a pixel value of a specific pixel in each pixel of the video.

The determining whether the difference between the pixels values is equal to or greater than the threshold value (S440) may include calculating the difference between pixel values for a specific pixel corresponding to the specific position of the ID card image 230 in at least two frames by the image determining unit 140, and determining whether the difference is equal to or greater than the threshold value.

For example, the image determining unit 140 may calculate the difference between the first pixel value of the first pixel in the first frame and the second pixel value of the first pixel in the second frame positioned at a time point after the first frame. For example, the image determining unit 140 may calculate the difference between the second pixel value of the first pixel in the second frame and a third pixel value of the first pixel in a third frame positioned at a time point after the second frame.

The image determining unit 140 may determine whether the calculated difference is equal to or greater than the threshold value. When the difference between the pixel values is equal to or greater than the threshold value, the color of the ID card image 230 is changed depending on the angles. Accordingly, the image determining unit 140 may determine the identifying mark as being present on the ID image 230. When the difference between the pixel values is less than the threshold value, the color of the ID image 230 is not changed depending on the angles. Accordingly, the image determining unit 140 may determine the identifying mark as being absent on the ID card image 230.

When the identifying mark is present on the ID card image 230, the image determining unit 140 may classify a video, which is pre-processed, as a video having the identifying mark in S420. The video classified in S450 may be used to train the AI model, with the identifying mark (S180).

In addition, when the identifying mark is absent on the ID card image 230, the image determining unit 140 may classify the video, which is pre-processed, as a video having no the identifying mark in S420. The video classified in S470 may be used to train the AI model, without the identifying mark (S480).

When the identifying mark is present on the video, the controller 110 may generate the first modified video having the first resolution value and the second modified video having the second resolution value, by changing the resolution of the video. Thereafter, the controller 110 may classify the first modified video and the second modified video as videos having identifying marks, and the classified videos may be used to train the AI mode with the identifying mark.

When the identifying mark is absent on the video, the controller 110 may generate a third modified video having a third resolution value and a fourth modified video having a fourth resolution value by changing the resolution of the video. Thereafter, the controller 110 may classify the third modified video and the fourth modified video as videos having no identifying mark, and the classified videos may be used to train the AI mode without the identifying mark.

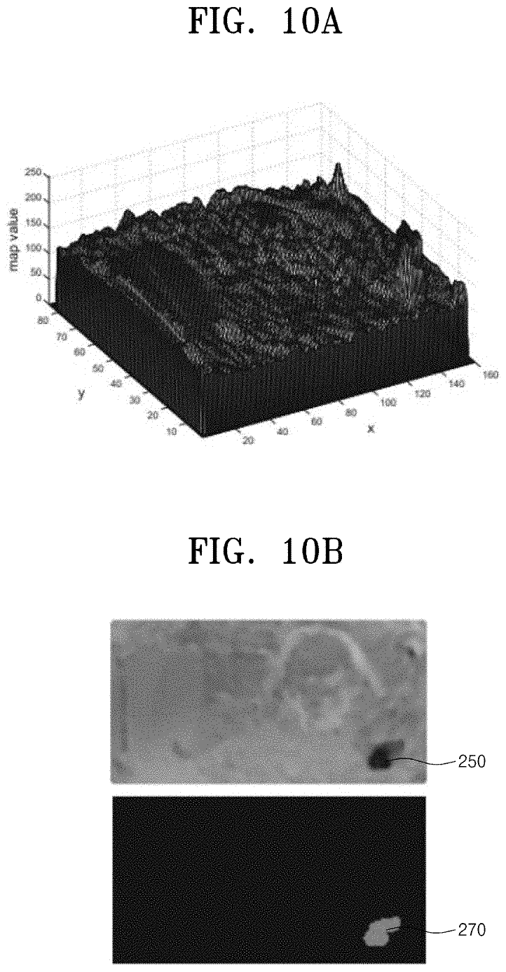

FIGS. 10A and 10B are views illustrating the step of comparing pixel values to extract an identifying mark by a device for determining an ID card, according to another embodiment.

FIG. 10A is a graph illustrating a pixel value of each pixel at a specific frame, and FIG. 10B illustrate views an image 250 having a first pixel value of a first pixel at a first frame and an image 270 having a second pixel value of the first pixel at a second frame.

Referring to FIGS. 10A and 10B, it may be recognized that the first frame and the second frame have different pixel values in the first pixel. Specifically, the difference between the first pixel value in the image 250 and the second pixel value in the image 270 may be equal to or greater than a threshold value. Accordingly, the image determining unit 140 may determine the identifying mark as being present at a position corresponding to the first pixel. The image determining unit 140 may classify an image having the first frame and the second frame as an image having an identifying mark. The controller 110 may train the AI model by using a video classified as a video having the identifying mark.

The method according to an embodiment may be implemented in the form of a program instruction and may be recorded in a computer-readable recording medium. The computer-readable storage medium may also include program instructions, data files, data structures, or a combination thereof. The program instructions recorded in the medium may be designed and configured specially for the embodiment or may be known and available to those skilled in computer software. The computer-readable storage medium may include a hardware device, which is specially configured to store and execute program instructions, such as magnetic media (e.g., a hard disk drive and a magnetic tape), optical media (e.g., CD-ROM and DVD), magneto-optical media (e.g., a floptical disk), a read only memory (ROM), a random access memory (RAM), or a flash memory. Examples of program instructions include not only machine language codes created by a compiler, but also high-level language codes that are capable of being executed by a computer by using an interpreter or the like. The hardware device described above may be configured to act as one or more software modules to perform the operation of the embodiment, or vice versa.

According to an embodiment of the present disclosure, there may be provided a device for determining an ID card, capable of detecting a counterfeit ID card by determining whether an identifying mark is present on an ID card.

According to an embodiment of the present disclosure, there may be provided a device for determining an ID card, capable of evaluating the performance of an artificial intelligent (AI) model used for determining an ID card.

While embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A device for detecting a counterfeit identification (ID) card, the device comprising:
an image input unit configured to acquire an initial image including an ID card image;
an image pre-processing unit configured to generate a processed image by removing a remaining portion of the initial image except for the ID card image, and generate a first training image having a first resolution value and a second training image having a second resolution value based on the processed image;
an image determining unit configured to determine whether an identifying mark is present on the processed image based on an artificial intelligence (AI) model based on a neural network trained by training data including the first training image and the second training image; and
a model evaluating unit configured to calculate a plurality of parameters by using a determination result of the image determining unit and evaluate the AI model based on the plurality of parameters.

2. The device of claim 1, wherein the identifying mark is a hologram or a micro-printed character.

3. The device of claim 1, wherein the image pre-processing unit generates the processed image by cropping an image, which is obtained by removing the remaining portion of the initial image except for the ID card image, to be in a specific size.

4. The device of claim 1, wherein the plurality of parameters includes at least one precision, recall and an area under curve (AUC) score.

5. The device of claim 4, wherein the plurality of parameters are calculated based on True Positive (TP), False Positive (FP), True Negative (TN), and False Negative (FN) calculated by using the determination result.

6. The device of claim 1, further comprising:
a result outputting unit configured to output at least one of the determination result or the plurality of parameters.

7. The device of claim 1, wherein the image determining unit determines whether the identifying mark is present based on a threshold value which is determined based on a False Acceptance Rate (FAR) and a False Rejection Rate (FRR), and adjusts the threshold value based on the plurality of parameters.

8. A method for detecting a counterfeit ID card by at least one processor, the method comprising:
acquiring an initial image including an ID card image;
generating a processed image by removing a remaining portion of the initial image except for the ID card image;
generating a first training image having a first resolution value and a second training image having a second resolution value, based on the processed image;
training an artificial intelligence (AI) model based on a neural network trained by training data including the first training image and the second training image;
determining whether the identifying mark is present on the processed image, based on the AI model;
calculating a plurality of parameters by using a determination result in the determining of whether the identifying mark is present on the processed image; and
evaluating the AI model based on the plurality of parameters.

9. The method of claim 8, wherein the identifying mark is a hologram or a micro-printed character.

10. The method of claim 8, wherein the generating of the processed image includes:
cropping an image, which is obtained by removing the remaining portion of the initial image except for the ID card image, to be in a specific size.

11. The method of claim 8, wherein the plurality of parameters includes at least one precision, recall and an area under curve (AUC) score.

12. The method of claim 11, wherein the calculating of the plurality of parameters includes:
calculating the plurality of parameters based on True Positive (TP), False Positive (FP), True Negative (TN) and False Negative (FN) calculated by using the determination result.

13. The method of claim 8, further comprising:
outputting at least one of the determination result or the plurality of parameters.

14. The method of claim 8, wherein the determining of whether the identifying mark is present includes: determining whether the identifying mark is present based on a threshold value which is determined based on a False Acceptance Rate (FAR) and a False Rejection Rate (FRR); and
adjusting the threshold value based on the plurality of parameters.

15. A computer program stored in a computer-readable recording medium to execute the method for detecting the counterfeit ID card, according to claim 8.
